(19) United States
(12) Patent Application Publication
(10) Pub. No.: US 2016/0328077 A1
(43) Pub. Date: Nov. 10, 2016

(54) TOUCH SENSOR

(71) Applicant: HEWLETT-PACKARD DEVELOPMENT COMPANY, L.P., Houston, TX (US)

(72) Inventor: Ronald DeMena, III, Batavia, NY (US)

(21) Appl. No.: 15/105,201

(22) PCT Filed: Jan. 31, 2014
(86) PCT No.: PCT/US14/14016

§ 371 Date: Jun. 16, 2016

(51) Int. Cl. G06F 3/041; G06F 3/0346; G06F 1/32

(52) U.S. Cl. CPC G06F 3/0416; G06F 1/3231; G06F 1/3234; G06F 3/0346; G06F 2203/04104; G06F 2200/1636

(57) ABSTRACT

An example of an electronic device is described herein. The electronic device can include a housing. The housing can include a front surface bordering a display of the electronic device. The housing can also include a back surface opposite the front surface. The housing can further include a plurality of side surfaces substantially perpendicular to the front surface and the back surface and joining the front surface to the back surface. A touch sensor can extend over substantially all portions of the front surface, back surface, and side surfaces.

### BACKGROUND

An electronic device can include a variety of devices for interacting with the electronic device. These devices can be integral components of the electronic device, or the devices can be external devices coupled to the electronic device. Examples of the devices for interacting with the electronic device can include a mouse, a touchpad, a joystick, or a combination thereof, among others.

### BRIEF DESCRIPTION OF THE DRAWINGS

Certain examples are described in the following detailed description and in reference to the drawings, in which:

FIG. 1 is a block diagram of an example of an electronic device that includes a housing touch sensor;

FIG. 2A is an illustration of a front view of an example of an electronic device that includes a housing touch sensor;

FIG. 2B is an illustration of a back view of an example of the electronic device that includes a housing touch sensor;

FIG. 3A is an illustration of a front view of an example of a user's hand interacting with the electronic device that includes a housing touch sensor;

FIG. 3B is an illustration of a back view of an example of the user's hand interacting with the electronic device that includes a housing touch sensor;

FIG. 4A is an illustration of an example of a user's hand position for holding the electronic device;

FIG. 4B is an Illustration of an example of a user's hand position for holding the electronic device;

FIG. 4C is an illustration of an example of a user's hand position for holding the electronic device;

FIG. 4D is an illustration of an example of a user's hand position for holding the electronic device;

FIG. 5 is an illustration of an example of a user's hand position relative to device orientation; and

FIG. 6 is a process flow diagram of an example of a method of interacting with an electronic device.

### DETAILED DESCRIPTION OF SPECIFIC EMBODIMENTS

An electronic device can include a variety of devices, integral or external to the device, for interacting with the device. A popular method of interacting with a mobile device, such as a tablet computer, is via a touchscreen and, optionally, physical buttons, such as volume buttons, a power button, or a home button. Using a touchscreen, a user can navigate through the mobile device. However, touch interactions in front of or on the screen can be intrusive to the observable space of the device. In addition, the physical buttons can be subject to accidental touches by a user, initiating an unintended response that interrupts the user's experience with the mobile device. Additionally, the physical buttons can be subject to physical damage, such as contacting another surface, as is the case when the device is dropped.

However, by extending a touch sensor across substantially all of the external surfaces of the housing of the device, a user can interact with the device without using the screen and potentially intruding on the screen of the device. Additionally, by making it possible for a user to interact with the device by touching any surface of the housing of the device, the user can interact with the device in a potentially easier and more comfortable way. Further, physical buttons can potentially be excluded from the device, thereby potentially increasing the sturdiness of the housing of the electronic device.

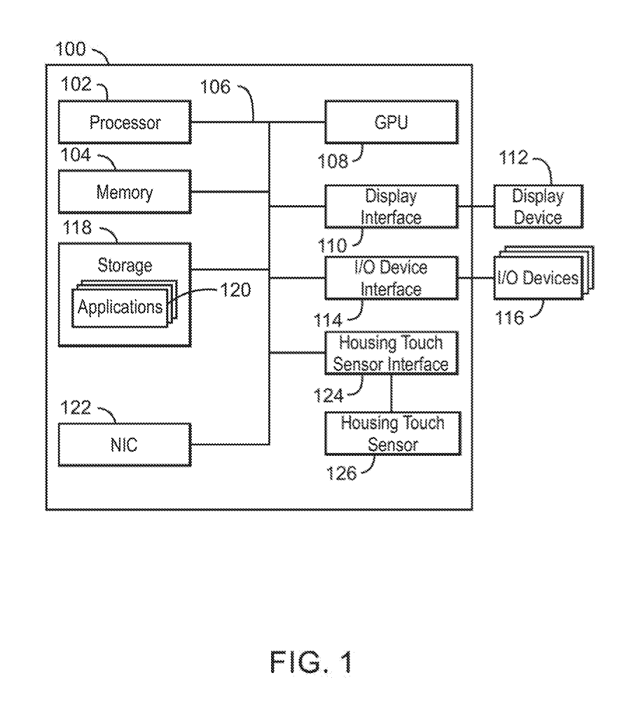

FIG. 1 is a block diagram of an example of an electronic device 100 that includes a housing touch sensor. The electronic device 100 can be a mobile device such as, for example, a tablet computer, a personal digital assistant (PDA), a cellular phone, such as a smartphone, or a music player, among others. The electronic device 100 can include a processor 102 to execute stored instructions, as well as a memory device 104 that stores instructions that are executable by the processor 102. The processor 102 can be coupled to the memory device 104 by a bus 106. Additionally, the processor 102 can be a single core processor, a multi-core processor, or any number of other configurations. Furthermore, the electronic device 100 can include more than one processor 102.

The memory device 104 can include random access memory (RAM), read only memory (ROM), flash memory, or any other suitable memory systems. For example, the memory device 104 can include dynamic random access memory (DRAM).

The electronic device 100 can also include a graphics processing unit (GPU) 108. As shown, the processor 102 can be coupled through the bus 106 to the GPU 108. The GPU 108 can perform any number of graphics operations within the electronic device 100. For example, the GPU 108 can render or manipulate graphics images, graphics frames, videos, or the like, to be displayed to a user of the electronic device 100. In some examples, the GPU 108 includes a number of graphics engines, wherein each graphics engine is configured to perform specific graphics tasks, or to execute specific types of workloads.

The processor 102 can be linked through the bus 106 to a display interface 110 to connect the electronic device 100 to a display device 112. The display device 112 can include a display screen that is a built-in component of the electronic device 100. The display device 112 can also include a computer monitor, television, or projector, among others, that is externally connected to the electronic device 100. In an example, the display device 112 can be a touchscreen.

The processor 102 can also be connected through the bus 106 to an input/output (I/O) device interface 114 to connect the electronic device 100 to one or more I/O devices 116. The I/O devices 116 can include, for example, a pointing device, wherein the pointing device can include a touchpad or a touchscreen, among others. The I/O devices 116 can be built-in components of the electronic device 100, or can be devices that are externally connected to the electronic device 100. In an example, the electronic device 100 can include a port, or a plurality of ports, for coupling an I/O device 116 to the electronic device 100.

The electronic device 100 also includes a storage device 118. The storage device 118 is a physical memory such as a hard drive, an optical drive, a thumbdrive, a secure digital (SD) card, a microSD card, an array of drives, or any combinations thereof, among others. The storage device 118 can also include remote storage drives. The storage device 118 includes any number of applications 120 that run on the electronic device 100.

A network interface card (NIC) 128 can connect the electronic device 100 through the system bus 106 to a network (not depicted). The network (not depicted) can be a wide area network (WAN), local area network (LAN), or the Internet, among others. In an example, the electronic device 100 can connect to the network (not depicted) via a wired connection or a wireless connection.

The electronic device 100 further includes a housing touch sensor interface 124 to connect the electronic device 100 to a housing touch sensor 126. The housing touch sensor 126 is a touch sensor that extends across substantially all external surfaces of a housing of the electronic device 100. In an example, the housing touch sensor 126 is a single touch sensor extending across substantially all external surfaces of the electronic device 100. In another example, the housing touch sensor 126 is a plurality of touch sensors distributed across the housing of the electronic device 100 which together cover substantially all external surfaces of the housing of the electronic device 100. For example, the housing touch sensor 126 can be a combination of sensors, such as a capacitive sensor, a resistive sensor, and a thermal sensor, arranged in a cluster. A plurality of clusters can be distributed across the housing of the electronic device 100, such as in an array, to cover substantially all external surfaces of the housing of the electronic device 100.

The housing touch sensor 126 can be any suitable type of touch sensor, such as a capacitive sensor, a resistive sensor, or a thermal sensor, among others. The housing touch sensor 126 can be embedded in the housing of the electronic device 100 or the housing touch sensor 126 can be externally applied to the housing of the electronic device 100, such as a film applied to the housing of the electronic device 100.

The housing touch sensor 126 facilitates interaction between a user's hand and the electronic device 100. For example, the housing touch sensor 126 can allow the user to interact with the electronic device without touching the display device 112. This interaction can be used, for example, when playing a game, watching a video, or displaying photos to friends, among others. The housing touch sensor 126 can be a touch sensor or a multi-touch sensor. The information collected by the housing touch sensor 126 can be used to distinguish between a hand holding the electronic device 100 and a hand interacting with the electronic device 100. For example, if a finger or multiple fingers are moved across the sensor, the electronic device 100 may respond to this action by enabling the user to interact with the electronic device 100. If, the hand holding the electronic device 100 is in a static position, the electronic device 100 may respond by disabling inputs to the electronic device 100 to prevent accidental pressing of a button. The housing touch sensor 126 renders substantially the entire surface of the housing of the electronic device 100 interactive. Accordingly, the entire surface of the housing of the electronic device 100 can be programmed to respond to a user's interaction touch, rather than limiting a user interaction touch to a specific area. Response to the user interaction touch can be programmable by the user, rather than being constrained by the design of the electronic device 100.

In an example, the housing touch sensor 126 can replace physical buttons on the electronic device 100, resulting in the electronic device including no physical buttons. Removing the physical buttons from the electronic device 100 can result in improved strength and stability of the housing of the electronic device 100. In another example, the electronic device 100 can include a physical button or physical buttons in addition to the housing touch sensor 126. The electronic device 100 can include a port, or a plurality of ports. The port can couple the electronic device 100 to another device, such as an I/O device 116. For example, the port can be a charging port. In an example, the port can be an opening in the housing of the electronic device 100. In this example, the housing touch sensor 126 surrounding the port can account for movement around the port and compensate for a lack of housing touch sensor 126 in the opening of the housing. In another example, a recessed panel can cover the port when the port is not in use. The recessed panel can include the housing touch sensor 126, sensing a user's touch across the port when the recessed panel covers the port. In a further example, the electronic device 100 can include no openings in the housing. For example, the electronic device 100 can couple to an I/O device 116 via a magnetic coupling, or any other suitable type of coupling that does not employ an opening in the housing.

It is to be understood the block diagram of FIG. 1 is not intended to indicate that the electronic device 100 is to include all of the components shown in FIG. 1 in every case. Further, any number of additional components can be included within the electronic device 100, depending on the details of the specific implementation.

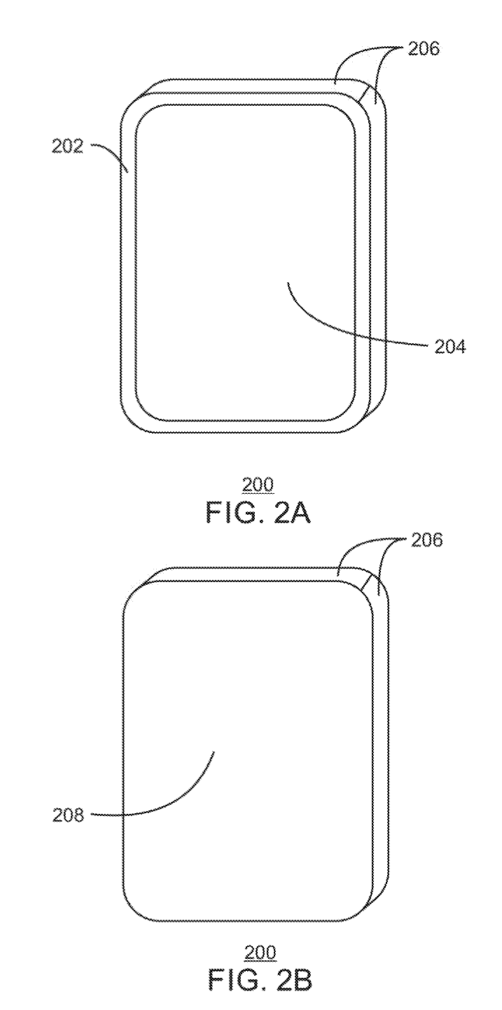

FIGS. 2A and 2B are front view and back view illustrations of an example of an electronic device that includes a housing touch sensor. The electronic device 200 can be a mobile device such as, for example, a tablet computer, a personal digital assistant (PDA), a music player, or a cellular phone, such as a smartphone, among others. The electronic device 200 includes a first surface 202. The first surface 202 forms a border that surrounds the display device 204. The electronic device 200 further includes side surfaces 206. The side surfaces 206 can be beveled edges or straight edges. The electronic device 200 further includes a second surface 208. The second surface 208 is opposite the first surface 202 and forms the back surface of the electronic device 200. The side surfaces 206 are substantially perpendicular to the first surface 202 and the second surface 208 and join the first surface 202 to the second surface 208.

The first surface 202, second surface 208, and side surfaces 206 form the external surfaces of the housing of the electronic device 200. The housing includes a touch sensor that extends across substantially all external surfaces 202, 206, 208 of the housing of the electronic device 200. The touch sensor can be any suitable type of touch sensor, such as a capacitive sensor, a resistive sensor, or a thermal sensor, among others. The touch sensor facilitates user interaction with the electronic device 200.

It is to be understood the illustrations of FIGS. 2A and 2B are not intended to indicate that the electronic device 200 is to include all of the components shown in FIGS. 2A and 2B in every case. Further, any number of additional features can be included within the electronic device 200, depending on the details of the specific implementation.

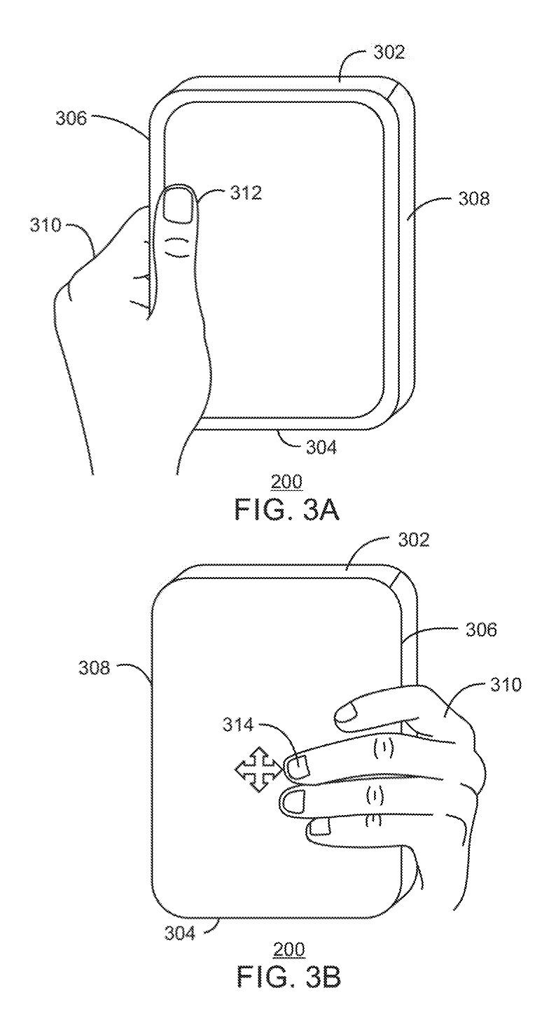

FIGS. 3A and 3B are front view and back view illustrations of an example of a user's hand interacting with an electronic device 200 that includes a housing touch sensor. The housing touch sensor extends across substantially all external surfaces of the housing of the electronic device 200. The electronic device 200 includes a top 302, a bottom 304, a left side 306, and a right side 308. A user's hand 310 can hold the electronic device 200 at any of the sides 302-308. For example, as illustrated in FIGS. 3a-b, the user's hand 310 can hold the electronic device 200 at the left side 306 of the electronic device. In holding the electronic device 200, the user's hand 310 substantially statically contacts the touch sensor. While the user's hand 310 is holding the electronic device 200, a user interaction touch can be applied to the touch sensor to interact with the electronic device 200. In an example, a digit 312 of the hand, such as the thumb, can move to apply a user interaction touch to a portion of the front surface of the touch sensor or to a portion of the left side surface of the touch sensor. In another example, a finger 314 of the hand 310 can move to apply a user interaction touch to the back surface of the touch sensor. In a further example, the user's second hand (not illustrated) can apply the user interaction touch while the user's hand 310 holds the electronic device 200.

The user interaction touch can be any type of mobile touch intended to initiate a response from the electronic device 200 (i.e., to interact with the electronic device 200). In an example, the user interaction touch can create a response on the display of the electronic device 200. For example, the user interaction touch can be a motion of a finger or fingers in a vertical or horizontal motion to scroll through a page on the display, to move a pointer on the display, or to control a game being played on the electronic device 200, among others. In another example, the user interaction touch can be to tap a finger or fingers on the touch sensor to select an object, play a video, stop, pause, return home, etc. In a further example, gesturing an arc on the touch sensor can enable panning of an image or adjustment of controls. Additionally, moving two fingers towards or away from each other can zoom in or out.

In an example, the back surface of the touch sensor can replicate the touch areas of the display, each area of the back surface corresponding to an area of the display. By selecting an area of the back surface, the user can select the corresponding area of the display. For example, when a user wishes to select an icon shown on the display, the user can tap the position on the back surface corresponding to the position of the icon on the display.

The touch sensor can be sensitive to pressure as well as movement. For example, sliding a greater or lesser pressured finger(s) in any given direction can cause panning or zoom. Sliding a finger along a side, such as the side opposite the hand 310 holding the electronic device 200, can control volume. In another example, the electronic device 200 can determine which of the user's hands is exerting a greater substantial pressure against the housing of the electronic device 200. The hand determined to be exerting the greater pressure is determined to be the hand holding the electronic device 200 and electronic device 200 can be configured to not respond to the hand holding the electronic device 200, rejecting the hand holding the electronic device 200 as to a non-user interaction touch. In another example, the electronic device 200 can determine that the palm of the hand holding the electronic device 200 is exerting a greater substantial pressure against the surface of the electronic device 200 than the hand not holding the electronic device 200 or a finger or fingers of the hand holding the electronic device 200. Accordingly, the electronic device 200 can reject the palm of the hand holding the electronic device 200 as a non-user interaction touch, while enabling the finger(s) of the hand holding the electronic device as a user-interaction touch. In this way, a user can interact with the electronic device 200 without repositioning the hand holding the electronic device 200 or employing the hand not holding the electronic device 200.

Additionally, a hidden gesture can unlock the electronic device. In an example, a hidden gesture or gestures can be used to protect the security of the electronic device 200. For example, when a user is using the electronic device 200 in a crowded room, the user can use a hidden gesture to unlock the device without alerting a member of the crowd that a security gesture has been used. The response of the electronic device 200 to each possible user interaction touch can be configured by a user. Any number of other user interaction touches, not described here, can also initiate a response from the electronic device 200. In an example, the response of the electronic device 200 to each possible user interaction touch can be configured by the electronic device based on the position of the user hand 310 holding the electronic device 200, the orientation of the electronic device 200, the position of the user interaction touch, the type of user interaction touch, or a combination thereof, among others.

In another example, the touch sensor can collect information about the user. For example, the touch sensor can collect medical information, such as a user's pulse or the voltage conducted by a user's skin. In another example, the touch sensor can collect electrocardiogram (EKG) information about the user. This medical information can be input in an application or other program of the electronic device 200. In this way, the electronic device 200 can monitor the health of the user via the touch sensor.

Further, the electronic device 200 can respond to a lack of user touch on the touch sensor. For example, when the electronic device 200 is placed on a surface and no user touch is detected by the touch sensor, the electronic device 200 can enter a sleep mode or an off mode. For example, when the electronic device 200 is placed front surface downward on a surface and no user touch is detected by the touch sensor, the electronic device 200 can enter a sleep mode or an off mode. In another example, when the electronic device 200 is in a sleep mode or an off mode and a user touch is detected by the touch sensor, the electronic device 200 can enter an awake mode or an on mode. In another example, sensing a user touch can be combined with information collected by other sensors of the electronic device 200, such as an accelerometer or a gyrometer, to initiate a response from the electronic device 200.

It is to be understood the illustrations of FIGS. 3A and 3B are not intended to indicate that the electronic device 300 is to include all of the components shown in FIGS. 3A and 3B in every case. Further, any number of additional features can be included within the electronic device 300, depending on the details of the specific implementation.

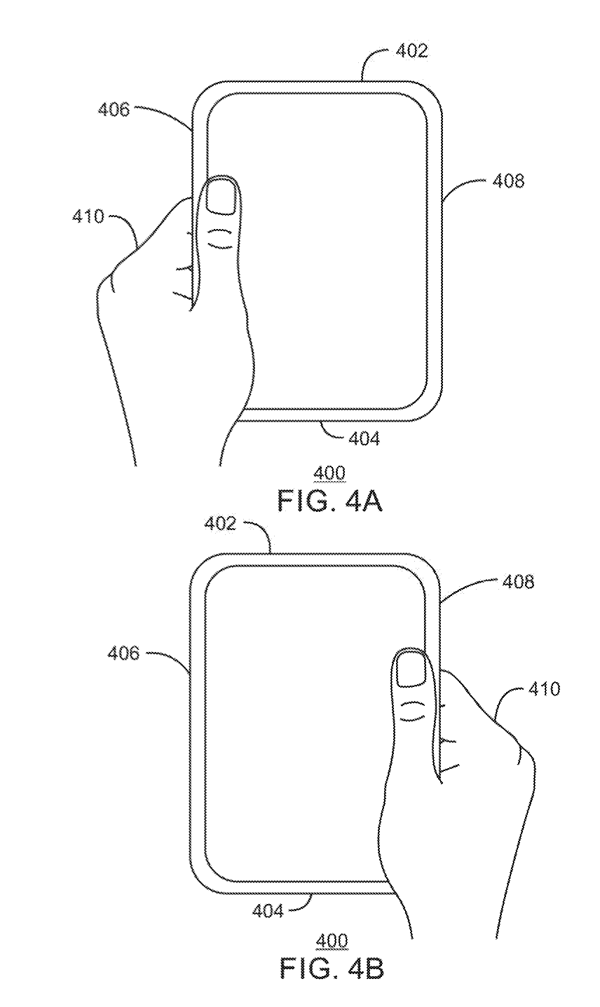

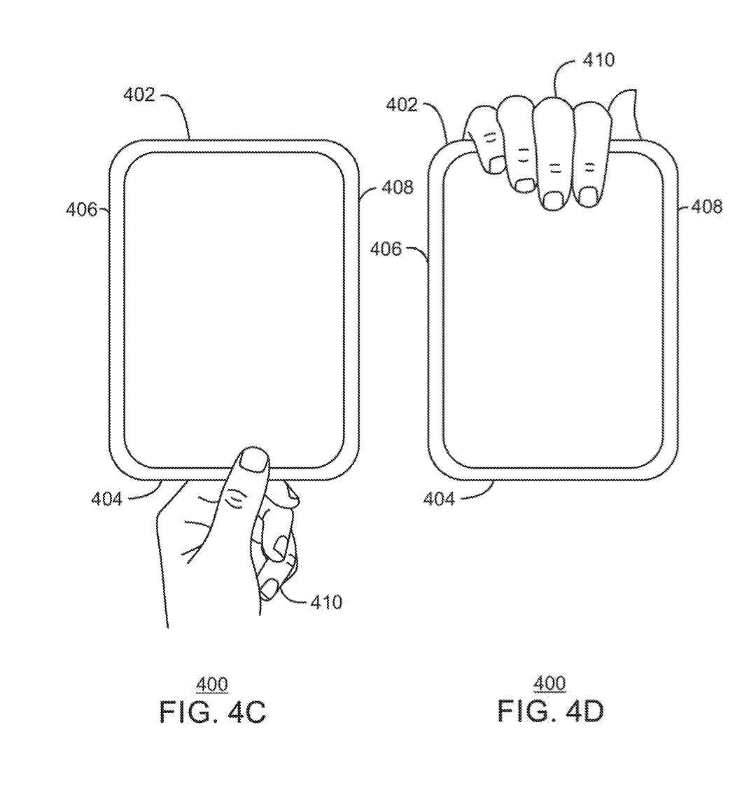

FIGS. 4A-4D are illustrations of examples of a user's hand positions for holding the electronic device 400. Substantially all external surfaces of the housing of the electronic device 400 are covered by a touch sensor. As a user's hand holds the electronic device 400, the user's hand will substantially statically (non-moving) contact the touch sensor. The electronic device 400 includes a top 402, a bottom 404, a left side 406, and a bottom side 408.

In FIG. 4A, the user's hand 410 is shown as holding the electronic device 400 at the left side 406 of the electronic device 400. In this position, the hand 410 holding the electronic device 400 will statically contact the touch sensor at the left side of the electronic device 400. This static touch covers a portion of the left front surface of the touch sensor, a portion of the left side surface of the touch sensor, and a portion of the left side of the back surface of the touch sensor.

In FIG. 4B, the user's hand 410 is holding the electronic device 400 at the right side 408 of the electronic device 400. In this position, the hand 410 holding the electronic device 400 statically contacts the touch sensor at the right side 408 of the electronic device 400. This static touch covers a portion of the right front surface of the touch sensor, a portion of the right side surface of the touch sensor, and a portion of the right side of the back surface of the touch sensor.

In FIG. 4C, the user's hand 410 is holding the electronic device 400 at the bottom of the electronic device 400. In this position, the hand 410 holding the electronic device 400 statically contacts the touch sensor at the bottom 404 of the electronic device 400. This static touch covers a portion of the bottom front surface of the touch sensor, a portion of the bottom side surface of the touch sensor, and a portion of the bottom of the back surface of the touch sensor.

In FIG. 4D, the user's hand 410 is holding the electronic device 400 at the top 402 of the electronic device 400. In this position, the hand 410 holding the electronic device 400 statically contacts the touch sensor at the top 402 of the electronic device 400. This static touch covers a portion of the top front surface of the touch sensor, a portion of the top side surface of the touch sensor, and a portion of the top of the back surface of the touch sensor.

It is to be understood the illustrations of FIGS. 4A-4D are not intended to indicate that the electronic device 400 is to include all of the components shown in FIGS. 4A-4D in every case. Further, any number of additional features can be included within the electronic device 400, depending on the details of the specific implementation. Additionally, while only four hand positions are illustrated in FIGS. 4a-d, a variety of hand positions not illustrated here are also possible for holding the electronic device 400.

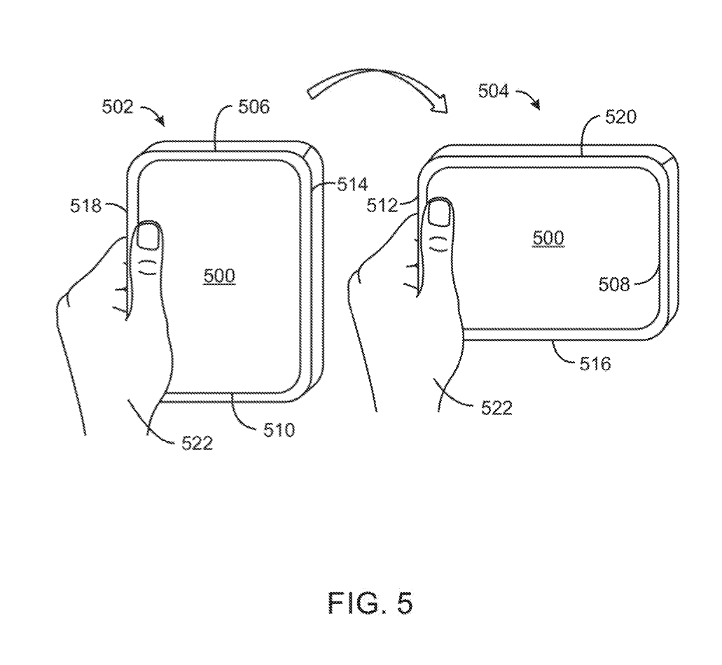

FIG. 5 is an illustration of an example of a user's hand position relative to device orientation. The housing of the electronic device 500 comprises a touch sensor extending across substantially all external surfaces of the housing of the electronic device 100. The electronic device 500 is rotated clockwise from a portrait orientation 502 to a landscape orientation 504. As is shown in FIG. 5, upon orientation from the portrait orientation 502 to the landscape orientation 504, the top 506 of the electronic device 500 becomes the right side 508 of the electronic device 500, the bottom 510 becomes the left side 512, the right side 514 becomes the bottom 516, and the left side 518 becomes the top 520. In portrait orientation 502, the user hand 522 is illustrated as holding the left side 518 of the electronic device and contacting the touch sensor at the left side 518 of the electronic device. The contact of the hand 522 holding the electronic device 500 is a relatively static (non-moving) contact with the electronic device 500. For example, the electronic device 500 can detect an absence of movement of the hand 522 over a predetermined period of time. In another example, the electronic device 500 can determine that the hand 522 is in contact with multiple surfaces simultaneously. For example, the electronic device 500 can determine that the hand 522 holding the electronic device 500 is in contact with the front of the electronic device 500, the left side 512 of the electronic device 500, and the back of the electronic device 500. In another example, a user hand contacting the housing to hold the electronic device can be determined to be a non-user interaction touch and the user's hand 522 contacting the housing to hold the electronic device does not initiate a response to a user interaction touch from the electronic device 500.

Upon rotation of the electronic device to the landscape orientation 504, the user's hand 522 moves to the left side 512 of the electronic device 500 (the bottom 510 of the electronic device 500 in portrait orientation 502) and contacts the touch sensor at the left side 512 of the electronic device 500.

The response of the electronic device 500 to a user interaction touch can be configured based on the position of the user's hand 522 holding the electronic device 500 and the orientation of the electronic device 500. For example, the response of the electronic device 500 can be to change the volume of audio produced by the electronic device 500 in response to sliding a user's finger up and/or down along a side of the electronic device 500. The response of the electronic device 500 can be configured so that, when the device is in portrait orientation 502 and the user hand 522 is holding the electronic device at the left side 518, the response of the electronic device (changing the volume) is initiated when the user interaction touch occurs on the upper right 514 of the electronic device 500. However, when the electronic device is in landscape orientation 504, the response can be configured to be initiated when the user interaction touch occurs on the upper right side 508 of the electronic device.

It is to be understood the illustration of FIG. 5 is not intended to indicate that the electronic device 500 is to include all of the components shown in FIG. 5 in every case. Further, any number of additional features can be included within the electronic device 500, depending on the details of the specific implementation.

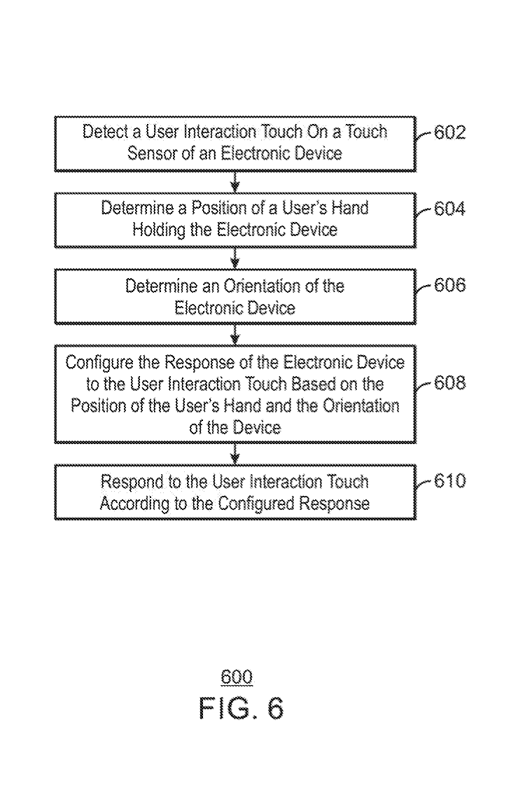

FIG. 6 is a process flow diagram of a method of interacting with an electronic device. The method 600 can be executed by an electronic device, such as the electronic device described with respect to FIG. 1. At block 602, a user interaction touch on a touch sensor of an electronic device can be detected. The touch sensor of the electronic device extends across substantially all external surfaces of a housing of the electronic device. The touch sensor can be any suitable type of touch sensor, such as a capacitive sensor, a resistive sensor, a thermal sensor, or a combination thereof, among others. The touch sensor facilitates interaction between a user and the electronic device.

At block 604, the position of a user's hand holding the electronic device can be determined. The user's hand holding the electronic device can be determined by determining a static contact of a user hand on the touch sensor. At block 606, the orientation of the electronic device can be determined. Determining the orientation of the electronic device includes determining if the device is in a portrait orientation or a landscape orientation. The orientation of the electronic device can be determined using any suitable type of sensor, such as an accelerometer or a gyrometer.

At block 608, the response of the electronic device to the user interaction touch can be configured based on the position of the user's hand and the orientation of the device. The response can additionally be configured based on the type of the user interaction touch and the location of the user interaction touch, or a combination thereof. In an example, configuring the response can include determining that the user's hand is holding the electronic device on the left side of the electronic device and the electronic device is in a portrait orientation and configuring a user touch on the upper right side of the electronic device to change the volume of audio on the electronic device. At block 610, the electronic device can respond to the user interaction touch according to the configured response.

It is to be understood that the process flow diagram of FIG. 6 is not intended to indicate that the steps of the method 600 are to be executed in any particular order, or that all of the steps of the method 600 are to be included in every case. Further, any number of additional steps not shown in FIG. 6 can be included within the method 600, depending on the details of the specific implementation.

What is claimed is:

1. An electronic device, comprising:
a housing, comprising:
a front surface bordering a display of the electronic device;
a back surface opposite the front surface; and
a plurality of side surfaces joining the front surface to the back surface; and
a touch sensor that extends over substantially all portions of the front surface, back surface, and side surfaces.

2. The electronic device of claim 1, wherein the touch sensor comprises a plurality of touch sensors, the plurality of touch sensors covering substantially all external surfaces of the housing.

3. The electronic device of claim 1, wherein when the electronic device is on a surface with the front surface facing down and a user touch is not detected by the touch sensor, the electronic device is to enter a sleep mode or an off mode.

4. The electronic device of claim 1, wherein when the electronic device is in a sleep mode or an off mode and a user touch is detected by the touch sensor, the electronic device is to enter an on mode or an awake mode.

5. The electronic device of claim 1, wherein the each area of the back surface is to correspond to an area of the display and wherein an area of the back surface is to be selected to select the corresponding area on the display.

6. The electronic device of claim 1, wherein a response to a user interaction touch detected by the touch sensor can be configured based on a detected position of a user hand contacting the housing to hold the electronic device.

7. The electronic device of claim 1, wherein a user hand contacting the housing to hold the electronic device can be determined to be a non-user interaction touch and wherein the user hand contacting the housing to hold the electronic device does not initiate a response to a user interaction touch from the electronic device.

8. The electronic device of claim 1, wherein a response to a user interaction touch detected by the touch sensor can be configured based on a location of the user interaction touch on the housing.

9. The electronic device of claim 1, wherein a response to a user interaction touch detected by the touch sensor can be configured based on a detected orientation of the electronic device.

10. A housing for a mobile device, comprising:
a plurality of external surfaces; and
a touch sensor extending across substantially all of the external surfaces,
the touch sensor to facilitate user interaction with the mobile device.

11. The housing of claim 10, wherein the touch sensor comprises a plurality of touch sensors, the plurality of touch sensors covering substantially all external surfaces of the housing.

12. The housing of claim 10, wherein a response to a user interaction touch detected by the touch sensor can be configured based on a detected position of a user hand contacting the housing to hold the electronic device, a location of the user interaction touch on the housing, a detected orientation of the electronic device, or a combination thereof.

13. A method, comprising:
detecting a user interaction touch on a touch sensor of an electronic device, the touch sensor of the electronic device extending across substantially all external surfaces of a housing of the electronic device;
determining a position of a user's hand holding the electronic device;
determining an orientation of the electronic device;
configuring a response of the electronic device to the user interaction touch based on the position of the user's hand and the orientation of the device; and
responding to the user interaction touch according to the configured response.

14. The method of claim 13, further comprising determining a type and location of the user interaction touch on the housing of the electronic device.

15. The method of claim 13, further comprising configuring the response of the electronic device based on the type of the user interaction touch, the position of the user's hand, the location of the user interaction touch, the orientation of the device, or a combination thereof.
